(19) United States
(12) Patent Application Publication
(10) Pub. No.: US 2017/0353761 A1
(43) Pub. Date: Dec. 7, 2017

(54) INFORMATION PROCESSING DEVICE AND INFORMATION PROCESSING METHOD

(71) Applicant: SONY CORPORATION, TOKYO (JP)

(72) Inventors: YASUSHI IHARA, TOKYO (JP); HIDEKI IWAMI, SAITAMA (JP); TOMOYA YAMAURA, TOKYO (JP)

(21) Appl. No.: 15/535,228

(22) PCT Filed: Oct. 20, 2015
(86) PCT No.: PCT/JP2015/079499

§ 371 Date: Jun. 12, 2017

(30) Foreign Application Priority Data
Dec. 29, 2014 (JP) 2014-266968

(51) Int. Cl. H04N 21/4363; H04W 12/06; H04N 21/4367

(52) U.S. Cl. CPC H04N 21/43637; H04N 21/4367; H04W 12/06

(57) ABSTRACT

To appropriately perform connection between information processing devices. The information processing device is an information processing device including a communication unit and a control unit. The communication unit is configured to perform image transmission to a first information processing device by using wireless communication. The control unit is configured to temporarily suspend the first information processing device and perform an authentication process with a second information processing device having a different role from the first information processing device if the second information processing device is newly connected when transmitting the image to the first information processing device.

### TECHNICAL FIELD

The present technology relates to an information processing device. More particularly, the present technology relates to an information processing device and information processing method of handling information related to wireless communication.

### BACKGROUND ART

Since the past, there have been wireless communication techniques of exchanging various kinds of data using wireless communication. For example, a wireless communication technique in which various kinds of information are exchanged between two information processing devices using wireless communication has been proposed (see, for example, Patent Literature 1).

### CITATION LIST

### Patent Literature

Patent Literature 1: JP 2008-278388A

### DISCLOSURE OF INVENTION

### Technical Problem

According to the technique of the related art described above, it is possible to exchange various kinds of information between the two information processing devices using wireless communication without being connected to a wired line. For example, an image based on image data transmitted from an information processing device on a transmission side is displayed on a display unit of an information processing device on a reception side.

As described above, when the information processing device on the reception side displays the image based on the image data transmitted from the information processing device on the transmission side on the display unit, another information processing device may be newly connected. In this case, the already connected information processing device may also perform the role of a relay device for transferring image data exchanged between the newly connected information processing device and the other already connected information processing device.

Further, when the information processing device on the reception side displays the image based on the image data transmitted from the information processing device on the transmission side via the relay device on the display unit, any one information processing device may be disconnected. In this case, the relay device may also perform the role of the information processing device on the reception side or the information processing device on the transmission side.

As described above, when the information processing device is newly connected or disconnected, the role of the other information processing device may change. Further, due to such a change, a fuzzy image or a black image may be generated. In this regard, it is important to properly perform connection between the information processing devices and prevent the occurrence of a fuzzy image or a black image.

The present technology was made in light of the foregoing, and it is an object of the present technology to properly perform a connection between the information processing devices.

### Solution to Problem

The present technology has been made to solve the above problem. According to a first aspect of the present technology, there is provided an information processing device, an information processing method, and a program causing a computer to execute the information processing method. The information processing device includes: a communication unit configured to perform image transmission to a first information processing device by using wireless communication; and a control unit configured to temporarily suspend the first information processing device and perform an authentication process with a second information processing device having a different role from the first information processing device if the second information processing device is newly connected when the image transmission is performed. Accordingly, an operation in which, when the second information processing device having a different role from the first information processing device is newly connected, the authentication process with the second information processing device is performed after temporarily suspending the first information processing device is obtained.

In addition, according to the first aspect, the communication unit may perform real time image transmission to the first information processing device in accordance with a Wireless Fidelity (Wi-Fi) CERTIFIED Miracast specification (technical specification name: Wi-Fi Display), and after the first information processing device is temporarily suspended, the control unit may perform an HDCP reauthentication process with each of the first information processing device and the second information processing device. Accordingly, an operation in which the HDCP reauthentication process with each of the first information processing device and the second information processing device is performed after temporarily suspending the first information processing device is obtained.

In addition, according to the first aspect, if a role of the first information processing device is a transmitter, and a role of the information processing device is a receiver in a case where the image transmission is performed, when the role of the information processing device is changed to a relay device due to a connection of the second information processing device, the control unit may perform the authentication process with the second information processing device after temporarily suspending the image transmission from the first information processing device, and resume the image transmission from the first information processing device after the authentication process. Accordingly, an operation in which, after the image transmission from the first information processing device is temporarily suspended, the authentication process with the second information processing device is performed, and the image transmission from the first information processing device is resumed after the authentication process is obtained.

In addition, according to the first aspect, the control unit may perform a reauthentication process with the first information processing device after temporarily suspending the image transmission from the first information processing device, and perform the authentication process with the second information processing device after the reauthentication process succeeds. Accordingly, an operation in which, after the image transmission from the first information processing device is temporarily suspended, the reauthentication process with the first information processing device is performed, and after the reauthentication process succeeds, an authentication process with the second information processing device is performed is obtained.

In addition, according to the first aspect, if a role of the first information processing device is a receiver, and a role of the information processing device is a transmitter in a case where the image transmission is performed, when the role of the information processing device is changed to a relay device due to a connection of the second information processing device, the control unit may perform the authentication process with the second information processing device after temporarily suspending the image transmission to the first information processing device, and resume the image transmission to the first information processing device after the authentication process. Accordingly, an operation in which, after the image transmission to the first information processing device is temporarily suspended, the authentication process with the second information processing device is performed, and the image transmission to the first information processing device is resumed after the authentication process is obtained.

In addition, according to the first aspect, the control unit may transmit Revocation information held when a wireless connection with the first information processing device starts to the second information processing device before performing the authentication process with the second information processing device. Accordingly, an operation in which Revocation information held when the wireless connection with the first information processing device starts is transmitted to the second information processing device before the authentication process with the second information processing device is performed is obtained.

In addition, according to the first aspect, the information processing device may be a dual role device satisfying a wireless Fidelity (Wi-Fi) CERTIFIED Miracast specification. Accordingly, an operation in which the connection process is performed by the dual role device of a Wi-Fi CERTIFIED Miracast specification is obtained.

In addition, according to a second aspect of the present technology, there is provided an information processing device, an information processing method, and a program causing a computer to execute the information processing method. The information processing device includes: a communication unit configured to relay image transmission from a first information processing device to a second information processing device by using wireless communication; and a control unit configured to perform a reauthentication process with the first information processing device after temporarily suspending the first information processing device and resume the image transmission from the first information processing device after the reauthentication process when disconnecting a connection with the second information processing device. Accordingly, an operation in which, when connection with the second information processing device is disconnected, after the first information processing device is temporarily suspended, the reauthentication process with the first information processing device is performed, and the image transmission from the first information processing device is resumed after the reauthentication process is obtained.

In addition, according to the second aspect, the control unit may perform a disconnection process from the second information processing device after temporarily suspending the first information processing device. Accordingly, an operation in which the disconnection process with the second information processing device is performed after the first information processing device is temporarily suspended is obtained.

In addition, according to a third aspect of the present technology, there is provided an information processing device, an information processing method, and a program causing a computer to execute the information processing method. The information processing device includes: a communication unit configured to relay image transmission from a first information processing device to a second information processing device by using wireless communication; and a control unit configured to cause notification information indicating that a connection with the first information processing device is to be disconnected to be output from at least one of the information processing device and the second information processing device when disconnecting the connection with the first information processing device. Accordingly, an operation in which, when the connection with the first information processing device is disconnected, the notification information indicating that the connection with the first information processing device is disconnected is output from at least one of the first information processing device and the second information processing device is obtained.

In addition, according to the third aspect, the control unit may cause the output to be performed through a display of the notification information or an audio output of the notification information. Accordingly, an operation in which the notification information is output through a display of the notification information or an audio output of the notification information is obtained.

### Advantageous Effects of Invention

According to the present technology, it is possible to obtain an excellent effect that a connection between the information processing devices can be performed appropriately. Note that the advantageous effects described above are not necessarily limitative, and the advantageous effects described in the present disclosure may be achieved.

### BRIEF DESCRIPTION OF DRAWINGS

FIG. 1 is a block diagram illustrating an exemplary functional configuration of an information processing device 100 according to an embodiment of the present technology.

FIG. 2 is a block diagram showing an exemplary functional configuration of a communication unit according to an embodiment of the present technology.

FIG. 3 is an exemplary format of Revocation information exchanged between information processing devices constituting a communication system according to an embodiment of the present technology.

FIG. 4 is a diagram illustrating a system configuration example of a communication system according to an embodiment of the present technology.

FIG. 5 is a sequence chart illustrating an exemplary communication process of devices constituting a communication system according to an embodiment of the present technology.

FIG. 6 is a sequence chart illustrating an exemplary communication process of devices constituting a communication system according to an embodiment of the present technology.

FIG. 7 is a diagram illustrating a system configuration example of a communication system according to an embodiment of the present technology.

FIG. 8 is a sequence chart illustrating an exemplary communication process of devices constituting a communication system according to an embodiment of the present technology.

FIG. 9 is a sequence chart illustrating an exemplary communication process of devices constituting a communication system according to an embodiment of the present technology.

FIG. 10 is a diagram illustrating a system configuration example of a communication system according to an embodiment of the present technology.

FIG. 11 is a sequence chart illustrating an exemplary communication process of devices constituting a communication system according to an embodiment of the present technology.

FIG. 12 is a sequence chart illustrating an exemplary communication process of devices constituting a communication system according to an embodiment of the present technology.

FIG. 13 is a diagram illustrating a system configuration example of a communication system according to an embodiment of the present technology.

FIG. 14 is a sequence chart illustrating an exemplary communication process of devices constituting a communication system according to an embodiment of the present technology.

FIG. 15 is a sequence chart illustrating an exemplary communication process of devices constituting a communication system according to an embodiment of the present technology.

FIG. 16 is a flowchart illustrating an example of a procedure of a connection process by the information processing device 100 according to an embodiment of the present technology.

FIG. 17 is a flowchart illustrating an example of procedure of a disconnection process by the information processing device 100 according to an embodiment of the present technology.

FIG. 18 is a block diagram illustrating an example of a schematic configuration of a smartphone.

FIG. 19 is a block diagram illustrating an example of a schematic configuration of a car navigation device.

### MODE(S) FOR CARRYING OUT THE INVENTION

Hereinafter, modes for carrying out the present technology (hereinafter referred to as “embodiments”) will be described. The description will proceed the following order.

1. Embodiments (example in which information processing device having a different role is newly connected and information processing device is disconnected)
2. Application examples

### 1. Embodiments

### [Exemplary Configuration of Information Processing Device]

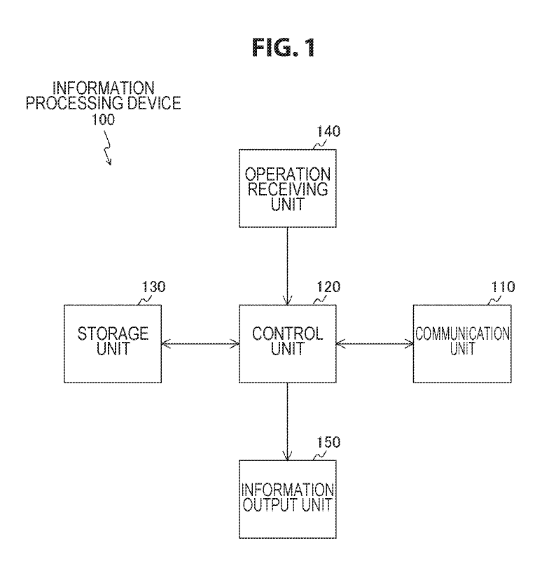

FIG. 1 is a block diagram illustrating an exemplary functional configuration of an information processing device 100 according to an embodiment of the present technology.

The information processing device 100 includes a communication unit 110, a control unit 120, a storage unit 130, an operation receiving unit 140, and an information output unit 150.

The information processing device 100 is an information processing device or an electronic device having a wireless communication function. For example, the information processing device 100 is an information processing device having a wireless communication function (for example, a personal computer or a video watching device (for example, a television)) or a portable information processing device (for example, a smartphone or a tablet terminal).

The communication unit 110 is a module for transmitting and receiving radio waves via an antenna (not illustrated) (for example, a wireless local area network (LAN) modem). For example, the communication unit 110 can perform wireless communication in accordance with a communication scheme of the wireless LAN.

For example, the communication unit 110 may perform wireless communication in accordance with a communication scheme conforming to institute of electrical and electronics engineers (IEEE) 802.11, IEEE 802.15, IEEE 802.16, or a 3rd generation partnership project (3GPP) specification (for example, wideband code division multiple access (W-CDMA), global system for mobile communications (GSM (registered trademark)), worldwide interoperability for microwave access (WiMAX), WiMAX2, long term evolution (LTE), LTE-advanced (LTE-A)). The communication unit 110 can exchange various kinds of information using the wireless communication function. For example, it is possible to perform wireless communication using a wireless LAN between devices.

As the wireless LAN, for example, wireless Fidelity (Wi-Fi) direct, tunneled direct link setup (TDLS), an ad hoc network, or a mesh network can be used. Further, for example, Wi-Fi CERTIFIED Miracast (technical specification title: Wi-Fi Display) can be used as short-range wireless audio visual (AV) transmission communication used by the communication unit 110. Wi-Fi CERTIFIED Miracast is a mirroring technique in which audio or a display image to be reproduced by one terminal is transmitted to another terminal using a technique of Wi-Fi Direct or TDLS, and audio and image data are similarly output in another terminal.

Further, in Wi-Fi CERTIFIED Miracast, user input back channel (UIBC) over transmission control protocol/Internet protocol (TCP/IP) is implemented. UIBC is a technique of transmitting operation information of an input device such as a mouse or a keyboard from one terminal to another terminal. Instead of Wi-Fi CERTIFIED Miracast, other remote desktop software (for example, virtual network computing (VNC)) may be applied.

As described above, the communication unit 110 can perform real time image transmission with other information processing devices in accordance with the Wi-Fi CERTIFIED Miracast specification. Further, the communication unit 110 can relay image transmission from a first information processing device to a second information processing device in accordance with the Wi-Fi CERTIFIED Miracast specification.

The control unit 120 controls the respective units of the information processing device 100 on the basis of a control program stored in the storage unit 130. The control unit 120 is implemented by, for example, a central processing unit (CPU). Further, for example, the control unit 120 performs signal processing of transmitted or received information. Further, for example, the control unit 120 performs a connection process, an authentication process, and a disconnection process with other information processing devices.

The storage unit 130 is a memory that stores various kinds of information. For example, the storage unit 130 stores various kinds of information (for example, a control program) necessary for the information processing device 100 to perform a desired operation. Further, for example, the storage unit 130 includes a buffer used when the information processing device 100 transmits and receives data.

The operation receiving unit 140 is an operation receiving unit that receives an operation input performed by the user, and outputs operation information according to the received operation input to the control unit 120. For example, the operation receiving unit 140 receives an instruction operation for connection to the network and an instruction operation for disconnection from the network. The operation receiving unit 140 is implemented by, for example, a touch panel, a keyboard, a mouse, and a sensor (for example, a touch interface).

The information output unit 150 is an output unit that outputs various kinds of information on the basis of the control of the control unit 120. As the information output unit 150, for example, a display unit (for example, an organic electro luminescence (EL) panel or a liquid crystal display (LCD) panel) that outputs various kinds of information by displaying it may be used. Further, as the information output unit 150, for example, an audio output unit (for example, a microphone) that outputs various kinds of information as sound may be used. As the information output unit 150, for example, both the display unit and the audio output unit may be used. The operation receiving unit 140 and the information output unit 150 may be integrally configured using a touch panel that enables the user to perform an operation input by bringing a finger into contact with or close to a display surface.

As described above, the information processing device 100 can establish a Wi-Fi Direct connection with another information processing device. Further, the information processing device 100 can perform image communication with another information processing device in accordance with Wi-Fi CERTIFIED Miracast.

As described above, when the information processing device 100 is Wi-Fi Direct connected, the information processing device 100 can detect a new connection of another information processing device. Similarly, when the information processing device 100 is performing image communication in accordance with Wi-Fi CERTIFIED Miracast, the information processing device 100 can detect a new connection of another information processing device.

Further, when the information processing device 100 is Wi-Fi Direct connected, the information processing device 100 can detect disconnection of another information processing device. Similarly, when the information processing device 100 is performing image communication in accordance with Wi-Fi CERTIFIED Miracast, the information processing device 100 can detect disconnection of another information processing device.

### [Exemplary Configuration of Communication Unit]

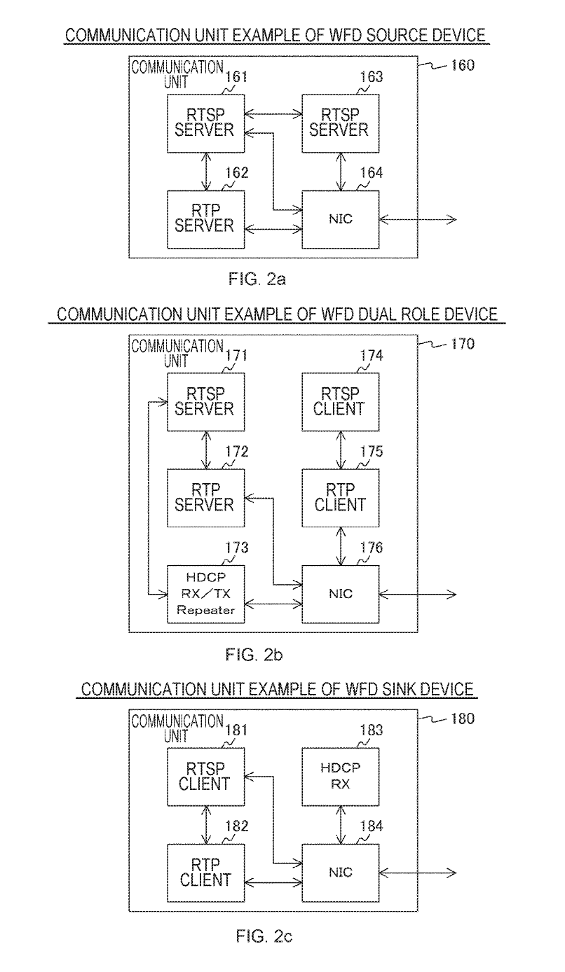

FIG. 2 is a block diagram illustrating an exemplary functional configuration of the communication unit according to the embodiment of the present technology. The communication unit corresponds to the communication unit 110 and the control unit 120 illustrated in FIG. 1.

In FIG. 2, a illustrates an example of a communication unit 160 of a source device of Wi-Fi Direct (WFD). The communication unit 160 includes a real time streaming protocol (RTSP) server 161, a real-time transport protocol (RTP) server 162, a high-bandwidth digital content protection system (HDCP) TX 163, and a network interface card (NIC) 164.

In FIG. 2, b illustrates an example of a communication unit 170 of a WFD Dual Role device (Dual Role device). The communication unit 170 includes an RTSP server 171, an RTP server 172, an HDCP RX/TX repeater 173, an RTSP client 174, an RTP client 175, and a NIC 176.

Here, a dual role device is an information processing device that can function as both of a sink device and a source device of Wi-Fi CERTIFIED Miracast.

In FIG. 2, c illustrates an example of a communication unit 180 of a sink device of WFD. The communication unit 180 includes an RTSP client 181, an RTP client 182, an HDCP RX 183, and a NIC 184.

### [Format Example of Revocation Information]

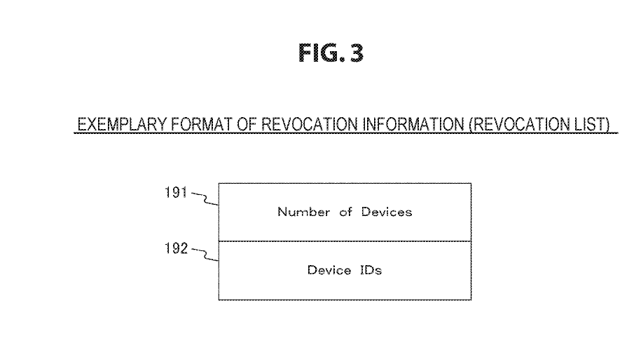

FIG. 3 is an example format of Revocation information exchanged between the information processing devices constituting the communication system according to the embodiment of the present technology.

The Revocation information is a list (Revocation List) which is managed by an upstream side device (a source device) and is used for monitoring whether or not an encryption key for encrypting a stream has leaked to a third party. Here, in the embodiment of the present technology, when communication of image data is performed, a reception side is indicated as “after” (or a downstream side), and a transmission side is indicated as “before” (or an upstream side).

The Revocation information is recorded, for example, in association with Number of Devices 191 and Device IDs 192.

The Number of Devices 191 is identification information identifying each device.

The Device IDs 192 are ID (identification) of each device.

Here, an HDCP digital rights management (DRM) technique will be described. In the HDCP DRM technique, devices are classified into three classes of a TX (Transmitter), a RX (Receiver), and a repeater, and a transmission path in which content is transmitted is protected.

Here, the TX is a device (transmitter) which transmits a digital stream without external digital input. Further, the RX is a device (receiver) that receives a digital stream without external digital output. Further, the repeater is a device (relay device) that has an external digital input and an external digital output and relays a stream digitally.

For example, the TX encrypts a stream to be transmitted to the RX. Further, the RX decrypts the stream (the stream encrypted by the TX) received from the TX. Further, after decrypting the stream (the stream encrypted by the TX) received from the TX, the Repeater encrypts the decrypted stream again and transmits the encrypted stream to the RX. In this case, the RX decrypts the stream (the stream encrypted by the repeater) received from the repeater.

As described above, the encrypted stream is exchanged between the TX and the RX. For this reason, authentication is performed between the TX and the RX, and an encryption key for encrypting the stream is exchanged. Further, the repeater performs authentication with each of the TX and the RX (that is, a total of two authentications), and exchanges the encryption key for encrypting the stream.

Further, in order to exclude an illegal device, the RX transmits the Revocation information to the TX.

Further, if there is a repeater between the RX and the TX, the repeater relays the Revocation information of the RX and transmits the Revocation information to the TX.

In Wi-Fi CERTIFIED Miracast, the transmission path is protected using HDCP. However, in Wi-Fi CERTIFIED Miracast, there are only two classes, that is, sink and source, and there is no class corresponding to the repeater. Further, each device can be a device (dual role device) that can function as the sink and the source. The sink device and the source device can be connected to the dual role device. Therefore, in Wi-Fi CERTIFIED Miracast, it is possible to connect the sink device with the source device via the dual role device.

Here, a case in which another device is added to the sink device and the source device that perform communication in accordance with Wi-Fi CERTIFIED Miracast is assumed. In this case, the role of the device on the side to which another device is added (the transmission side or the reception side) is also assumed to be changed. In this case, the role in HDCP is also changed. For example, in HDCP, the role is assumed to change from the TX to the repeater or from the RX to the repeater.

Further, any one of devices (the sink device and the source device) that perform communication in accordance with Wi-Fi CERTIFIED Miracast is assumed to be disconnected. In this case, the role of the device on the side from which the device is disconnected (the transmission side or the reception side) is changed. In this case, the role in HDCP is also changed. For example, in HDCP, the role is assumed to change from the TX to the repeater or from the RX to the repeater.

In HDCP, when the role of the device is changed as described above, re-authentication of HDCP is necessary. In the re-authentication of HDCP, it is necessary to disconnect the TCP connection of RTSP or the L2 connection of Wi-Fi Direct of the lower layer. Further, at the time of re-authentication of HDCP, a fuzzy image or a black image may occur. Further, from a point of view of the user, it may be difficult to view a display at the time of disconnection, or a black image may occur at the time of disconnection.

### [Example in Which RX is Added After RX]

First, an example in which a role of the first RX is changed to the repeater when an RX is further added after the RX will be described.

### [Exemplary Configuration of Communication System]

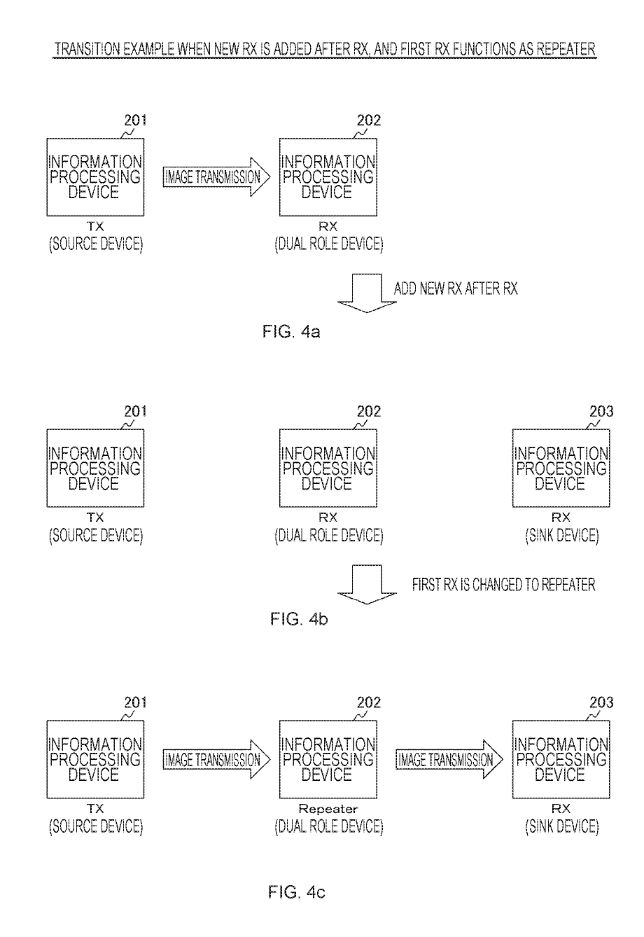

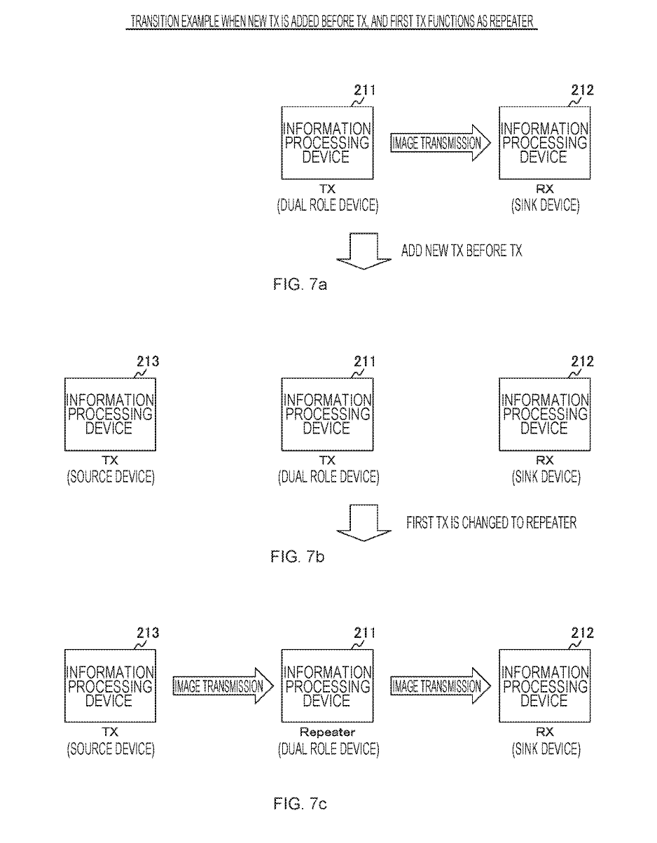

FIG. 4 is a diagram illustrating an exemplary system configuration of the communication system according to the embodiment of the present technology. Each of information processing devices 201 to 203 constituting a communication system illustrated in FIG. 4 corresponds to the information processing device 100 illustrated in FIG. 1. The roles (the TX, the RX, and the repeater) of the information processing devices in HDCP are illustrated below rectangles indicating the information processing devices 201 to 203. In parentheses below the roles, the roles (the source device, the sink device, and the dual role device) in Wi-Fi CERTIFIED Miracast are illustrated. Similarly, in FIGS. 7, 10, and 13, the roles of the information processing devices in HDCP and the roles thereof in Wi-Fi CERTIFIED Miracast are illustrated below rectangles indicating the information processing devices.

FIG. 4 illustrates a transition example in which the role of the first RX is changed to the repeater when the RX is further added after the RX.

In FIG. 4, a illustrates an example in which a stream is transmitted from the information processing device (TX) 201 to the information processing device (RX) 202 in accordance with Wi-Fi CERTIFIED Miracast.

In FIG. 4, b illustrates an example in which the information processing device (RX) 203 is added after the information processing device (RX) 202 in the state illustrated in a of FIG. 4. As described above, when the information processing device (RX) 203 is added, the role of the information processing device 202 is changed from the RX to the repeater.

In FIG. 4, c illustrates an example in which a stream is transmitted from the information processing device (TX) 201 to the information processing device (RX) 203 via the information processing device (the repeater) 202 in accordance with Wi-Fi CERTIFIED Miracast.

As illustrated in c of FIG. 4, even when the information processing device 203 is added after the information processing device 202, the information processing device 202 can display the image based on the stream from the information processing device 201.

For example, the information processing device 201 may be an imaging device (for example, a digital video camera), the information processing device 202 may be a tablet terminal, and the information processing device 203 may be a smartphone. For example, a case in which a captured image generated by the imaging device (information processing device 201) is first transmitted to the tablet terminal (the information processing device 202) and displayed is assumed. In this case, the smartphone (the information processing device 203) can be added and connected to the tablet terminal (the information processing device 202), and the display can be performed even on the smartphone (the information processing device 203). In this case, the captured image generated by the imaging device (the information processing device 201) can be displayed on both the tablet terminal (the information processing device 202) and the smartphone (the information processing device 203).

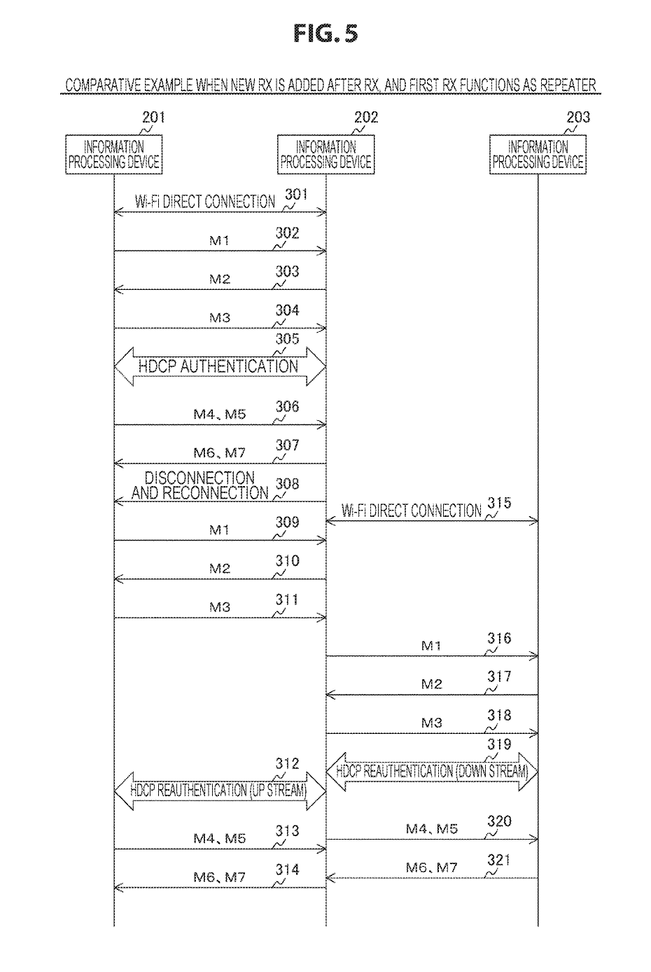

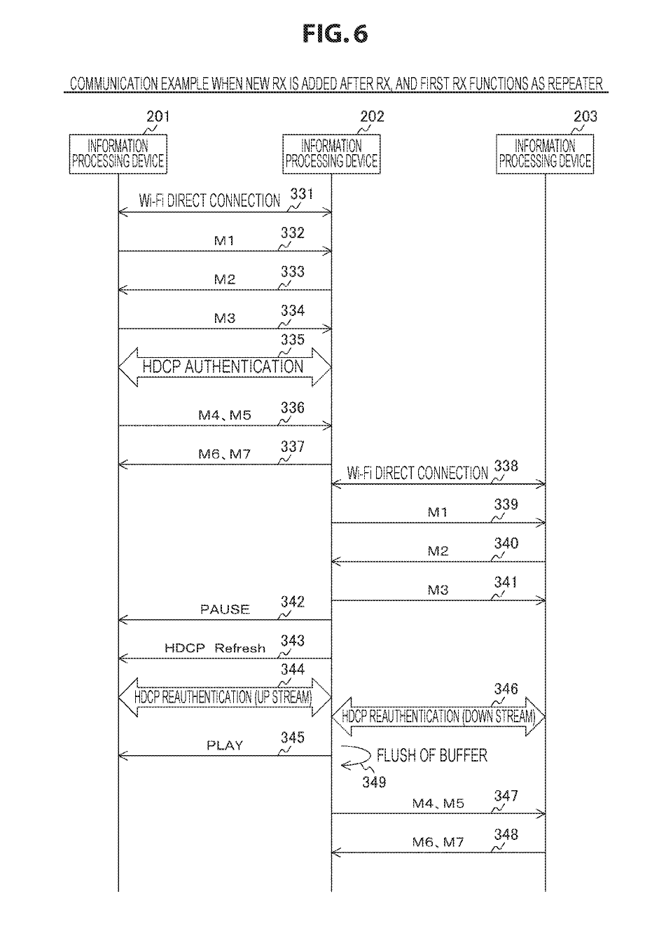

The communication examples will be described in detail with reference to FIGS. 5 and 6.

### [Communication Examples]

FIGS. 5 and 6 are sequence charts illustrating exemplary communication processes among the devices constituting the communication system according to the embodiment of the present technology. In other words, FIGS. 5 and 6 illustrate communication examples in which the role of the first RX is changed to the repeater when the RX is further added after the RX.

FIG. 5 illustrates a comparative example of the communication example illustrated in FIG. 6.

As illustrated in FIG. 5, when image transmission according to Wi-Fi CERTIFIED Miracast is performed between the information processing device 201 and the information processing device 202, a Wi-Fi Direct connection process is performed between the information processing device 201 and the information processing device 202 (301). Then, M1 to M3 messages are exchanged between the information processing device 201 and the information processing device 202 (302 to 304). Then, an HDCP authentication process is performed between the information processing device 201 and the information processing device 202 (305). Then, M4 to M7 messages are exchanged between the information processing device 201 and the information processing device 202 (306 and 307).

Here, M1 is a message (Query sink options) for inquiring about options of the sink device. Further, M2 is a message (Query source options) for inquiring about options of the source device.

M3 is a message (Query sink capabilities) for inquiring about capability information of the sink device. M4 is a message (Set sink parameters) for notifying the sink device of parameters to be set in the sink device.

M5 is a message indicating “Trigger WFD sink to issue {SETUP|PLAY|TEARDOWN|PAUSE} request.” Further, M6 is a message indicating “Send SETUP request to WFD source.” Further, M7 is a message indicating “Send PLAY request to WFD source. WFD source begins audio and/or video streaming.”

Here, the information processing device 203 is assumed to be further added after the information processing device 202. In this case, a disconnection process and a reconnection process are performed between the information processing device 201 and the information processing device 202 (308).

Further, the Wi-Fi Direct connection process is performed between the information processing device 202 and the information processing device 203 (315). Further, the exchange of the M1 to M7 messages (316 to 318, 320, and 321) and the HDCP reauthentication (319) are performed between the information processing device 202 and the information processing device 203.

Further, the information processing device 202 whose role is changed to the repeater performs the exchange of the M1 to M7 messages (309 to 311, 313, and 314) and the HDCP reauthentication (312) with the information processing device 201.

As described above, when the information processing device 203 is further added after the information processing device 202, it is necessary to perform the HDCP reauthentication. In this case, since it is necessary to disconnect the L2 connection of Wi-Fi Direct and TCP of RTSP, a fuzzy image or a black image may occur at the time of HDCP reauthentication. Further, at the time of HDCP reauthentication, there is a possibility of the authentication of the upstream side being performed again. In this regard, FIG. 6 illustrates an example in which the dual role device of Wi-Fi CERTIFIED Miracast performs the HDCP reauthentication of changing the role from the RX to the repeater without disconnecting the L2 connection of Wi-Fi Direct and the TCP connection of RTSP.

Further, respective processes (331 to 337 and 315 to 321) illustrated in FIG. 6 correspond to the respective processes (301 to 307 and 338 to 348) illustrated in FIG. 5. Thus, descriptions of the corresponding processes will be omitted.

The information processing device 202 issues PAUSE to the information processing device 201 before the HDCP reauthentication (342). Since it is possible to temporarily suspend the information processing device 201 by issuing PAUSE, it is possible to temporarily suspend an image. Accordingly, it is possible to prevent the occurrence of a fuzzy image or a black image at the time of HDCP reauthentication (344).

Then, the information processing device 202 issues HDCP Refresh to the information processing device 201 (343). Then, the information processing device 202 performs HDCP re-authentication (Up Stream) with the information processing device 201 (344). Further, the information processing device 202 performs HDCP re-authentication (Down Stream) with the information processing device 203 (346).

Then, the information processing device 202 issues PLAY to the information processing device 201 so that PLAY is set in the information processing device 201 (345).

Here, image data is continuously transmitted from the information processing device 201 after PAUSE is issued to the information processing device 201 (342). The image data transmitted as described above is held in the buffer of the information processing device 202. Therefore, the information processing device 202 can erase the image data by flushing the buffer at the timing of issuing PLAY to the information processing device 201 (349). In this case, the image data of the section is unable to be displayed, but since it is a relatively short period, influence on the user is small.

As described above, the information processing device 202 can delay a timing at which the authentication (346) on the downstream stream side, i.e., the repeater, is performed with the added information processing device 203 until the re-authentication (344) between the information processing device 201 and the information processing device 202 ends. Accordingly, it is possible to prevent the occurrence of a fuzzy image or a black image when the re-authentication (344) on the upstream (Up Stream) side fails. Further, it is possible to smoothly output images and sounds after the re-authentication without disconnecting the L2 connection of Wi-Fi Direct or the TCP connection of RTSP.

As described above, when the information processing device 203 having a different role from the information processing device 201 is newly connected, the control unit of the information processing device 202 (corresponding to the control unit 120 illustrated in FIG. 1) temporarily suspends the information processing device 201 and then performs the authentication process with the information processing device 203. In this case, the control unit of the information processing device 202 temporarily suspends the information processing device 201 and then performs the HDCP reauthentication process with each of the information processing device 201 and the information processing device 203. Specifically, the control unit of the information processing device 202 temporarily suspends the image transmission from the information processing device 201 and then performs the HDCP reauthentication process with the information processing device 201, and after the HDCP reauthentication process succeeds, the control unit of the information processing device 202 performs the HDCP reauthentication process with the information processing device 203. The control unit of the information processing device 202 resumes the image transmission from the information processing device 201 after the HDCP reauthentication process with the information processing device 203 succeeds.

### [Example in Which TX is Added Before TX]

Next, an example in which the role of the first TX is changed to the repeater when the TX is further added before the TX will be described.

### [Exemplary Configuration of Communication System]

FIG. 7 is a diagram illustrating an exemplary system configuration of a communication system according to the embodiment of the present technology. Each of information processing devices 211 to 213 constituting a communication system illustrated in FIG. 7 corresponds to the information processing device 100 illustrated in FIG. 1. FIG. 7 illustrates a transition example in which the role of the first TX is changed to the repeater when the TX is further added before the TX.

In FIG. 7, a illustrates an example in which a stream is transmitted from the information processing device (TX) 211 to the information processing device (RX) 212 in accordance with Wi-Fi CERTIFIED Miracast.

In FIG. 7, b illustrates an example in which the information processing device (TX) 213 is further added before the information processing device (TX) 211 in the state illustrated in a of FIG. 7. As described above, when the information processing device (TX) 213 is added, the role of the information processing device 211 is changed from the TX to the repeater.

In FIG. 7, c illustrates an example in which a stream is transmitted from the information processing device (TX) 213 to the information processing device (RX) 212 via the information processing device (the repeater) 211 in accordance with Wi-Fi CERTIFIED Miracast.

As illustrated in c of FIG. 7, even when the information processing device 213 is added before the information processing device 211, the information processing device 211 can transmit the stream to the information processing device 212 so that the image is displayed. In this case, for example, the information processing device 212 can simultaneously display an image based on the stream from the information processing device 213 and an image based on the stream from the information processing device 211 on the display unit. For example, the information processing device 212 may simultaneously display the image from the information processing device 213 and the image from the information processing device 211 on two screens.

For example, the information processing device 211 may be a tablet terminal with a camera, the information processing device 212 may be a tablet terminal, and the information processing device 213 may be an imaging device (for example, a digital video camera). For example, a case in which a captured image generated by the tablet terminal with a camera (the information processing device 211) is first transmitted to the tablet terminal (the information processing device 212) and displayed is assumed. In this case, an imaging device (the information processing device 213) can be added and connected to the camera tablet terminal (the information processing device 211), and a detailed image by the imaging device (the information processing device 213) can be displayed on the tablet terminal (the information processing device 212). In this case, the captured images generated by both the tablet terminal with the camera (the information processing device 211) and the imaging device (the information processing device 213) can be simultaneously displayed on the tablet terminal (the information processing device 212).

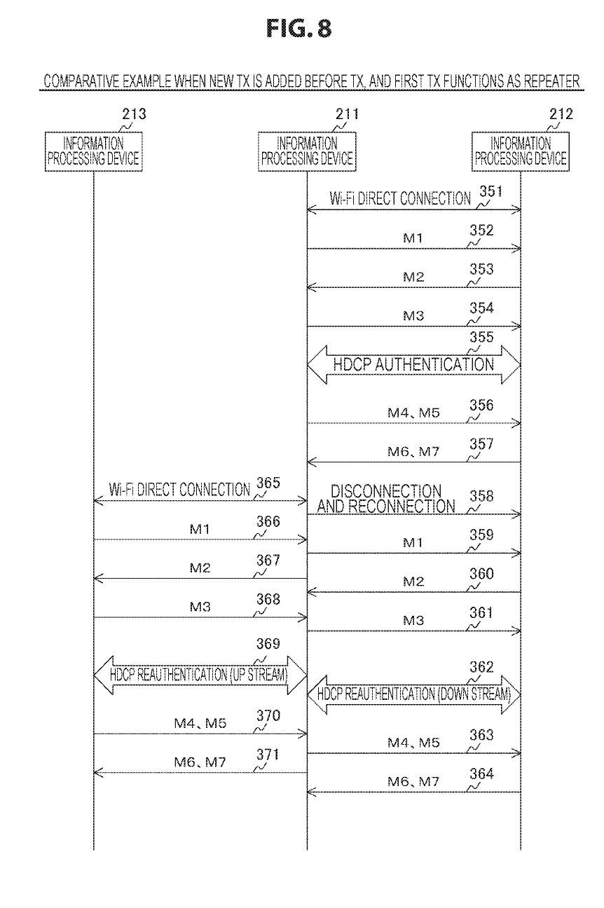

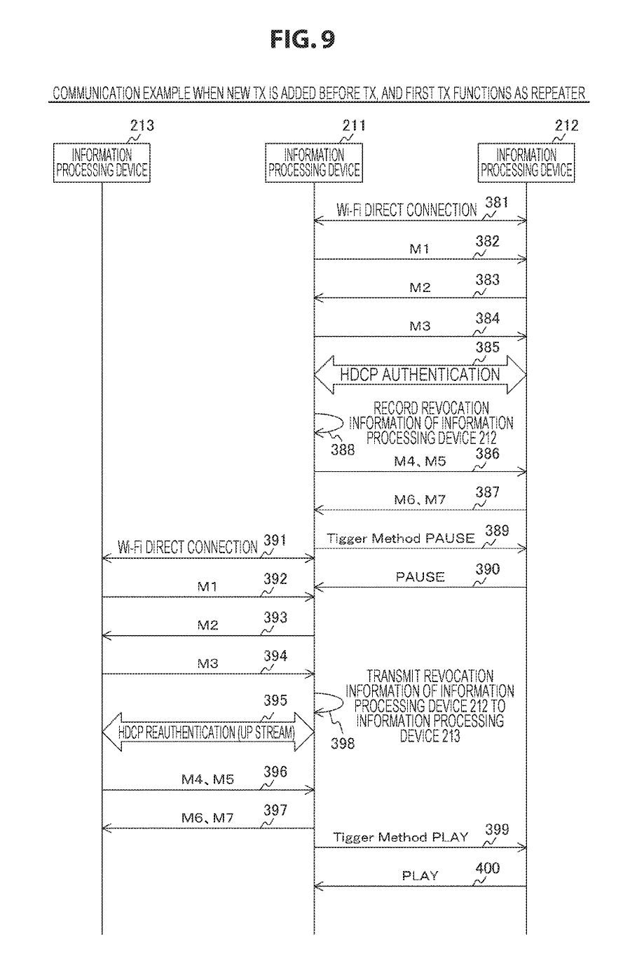

The communication examples will be described in detail with reference to FIGS. 8 and 9.

### [Communication Examples]

FIGS. 8 and 9 are sequence charts illustrating exemplary communication processes among devices constituting the communication system according to the embodiment of the present technology. In other words, FIGS. 8 and 9 illustrate communication examples in which the role of the first TX is changed to the repeater when the TX is further added before the TX.

FIG. 8 illustrates a comparative example of the communication example illustrated in FIG. 9.

Further, respective processes (351 to 371) illustrated in FIG. 8 correspond to the respective processes (301 to 321) illustrated in FIG. 5. Thus, descriptions of the corresponding processes will be omitted.

As described above, when the information processing device 213 is further added before the information processing device 211, it is necessary to perform the HDCP reauthentication. In this case, because it is necessary to disconnect the L2 connection of Wi-Fi Direct and TCP of RTSP, a fuzzy image or a black image may occur at the time of HDCP reauthentication. Further, at the time of HDCP reauthentication, there is a possibility of the authentication of the downstream side being performed again. In this regard, FIG. 9 illustrates an example in which the dual role device of Wi-Fi CERTIFIED Miracast performs the HDCP reauthentication of changing the role from the TX to the repeater without disconnecting the L2 connection of Wi-Fi Direct and the TCP connection of RTSP.

Further, respective processes (381 to 387, and 391 to 397) illustrated in FIG. 9 correspond to the respective processes (351 to 357, 365 to 371) illustrated in FIG. 8. Thus, descriptions of the corresponding processes will be omitted.

After the HDCP authentication (385), the information processing device 211 records the Revocation information of the information processing device 212 in the storage unit (corresponding to the storage unit 130 in FIG. 1) (388). Further, the information processing device 211 transmits the Revocation information of the information processing device 212 recorded in the storage unit to the information processing device 213 (398) before the HDCP reauthentication (395).

As described above, when the information processing device 211 is first connected to the information processing device 212, the Revocation information of the information processing device 212 is recorded. Then, when the information processing device 213 is added, the Revocation information of the information processing device 212 is transmitted to the information processing device 213.

Accordingly, repeater authentication (HDCP reauthentication (Down Stream)) can be omitted after the information processing device 211 performs the repeater authentication (HDCP reauthentication (Up Stream)) with the information processing device 213 (395).

Further, the information processing device 211 transmits a PAUSE command to the information processing device 212 through Trigger METHOD before the HDCP reauthentication (389 and 390). Since it is possible to temporarily suspend the information processing device 212 by transmitting the PAUSE command, the image can be temporarily suspended. Therefore, it is possible to prevent the occurrence of a fuzzy image or a black image at the time of HDCP reauthentication (395).

Further, after the repeater authentication (HDCP reauthentication (Up Stream)) (395) is performed, the information processing device 211 issues PLAY to the information processing device 212 through Trigger METHOD (399 and 400). Accordingly, PLAY can be set in the information processing device 212 (399 and 400).

As described above, when the information processing device 213 having a different role from the information processing device 212 is newly connected, the control unit of the information processing device 211 (corresponding to the control unit 120 illustrated in FIG. 1) temporarily suspends the information processing device 212 and then performs the authentication process with the information processing device 213. In this case, the control unit of the information processing device 211 temporarily suspends the image transmission to the information processing device 212, then performs an HDCP reauthentication process with the information processing device 213, and resumes the image transmission to the information processing device 212 after the HDCP reauthentication process succeeds. The control unit of the information processing device 211 transmits the Revocation information held when the wireless connection with the information processing device 212 starts to the information processing device 213 before the HDCP reauthentication process with the information processing device 213 is performed.

### [Example in Which RX is Disconnected]

Next, an example in which the role of the repeater is changed to the RX when the RX is disconnected will be described.

### [Exemplary Configuration of Communication System]

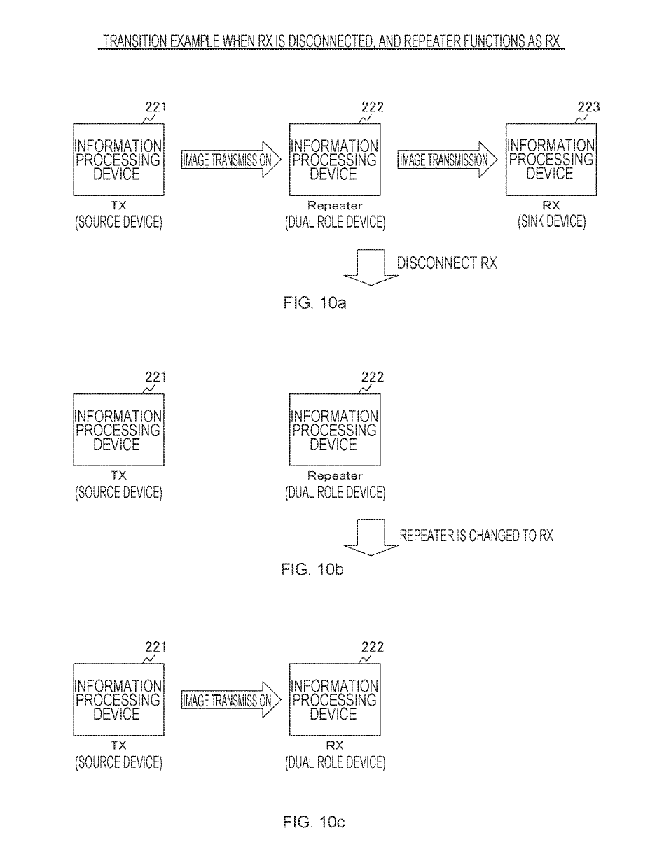

FIG. 10 is a diagram illustrating a system example system configuration of a communication system according to the embodiment of the present technology. Each of information processing devices 221 to 223 constituting a communication system illustrated in FIG. 10 corresponds to the information processing device 100 illustrated in FIG. 1. FIG. 10 illustrates a transition example in which the role of the repeater is changed to the RX when the RX is disconnected.

In FIG. 10, a illustrates an example in which a stream is transmitted from the information processing device (TX) 221 to the information processing device (RX) 223 via the information processing device (the repeater) 222 in accordance with Wi-Fi CERTIFIED Miracast.

In FIG. 10, b illustrates an example in which the information processing device (RX) 223 is disconnected (for example, TEARDOWN (termination processing) or radio disconnection) in the state illustrated in a of FIG. 10. As described above, when the information processing device (RX) 223 is disconnected, the role of the information processing device 222 is changed from the repeater to the RX.

In FIG. 10, c illustrates an example in which a stream is transmitted from the information processing device (TX) 221 to the information processing device (RX) 222 in accordance with Wi-Fi CERTIFIED Miracast.

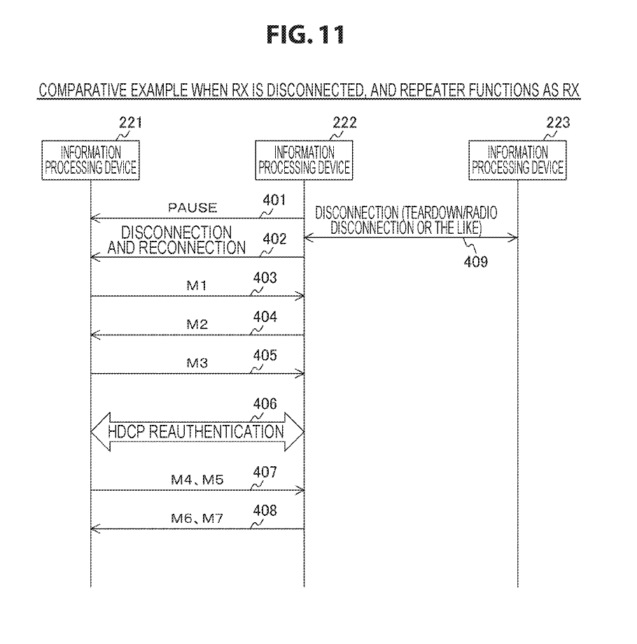

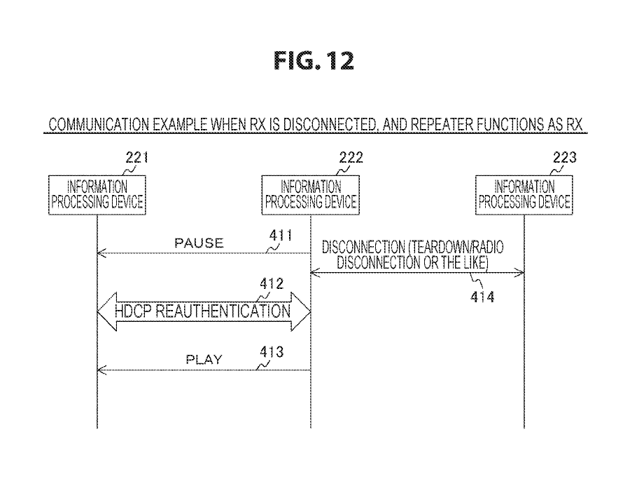

The communication examples will be described in detail with reference to FIGS. 11 and 12.

### [Communication Examples]

FIGS. 11 and 12 are sequence charts illustrating exemplary communication processes among devices constituting the communication system according to the embodiment of the present technology. In other words, FIGS. 11 and 12 illustrate communication examples in which the role of the repeater is changed to the RX when the RX is disconnected.

FIG. 11 illustrates a comparative example of the communication example illustrated in FIG. 12.

Further, respective processes (402 to 408) illustrated in FIG. 11 correspond to the respective processes (308 to 314) illustrated in FIG. 5. Thus, descriptions of the corresponding processes will be omitted.

When the information processing device 223 is disconnected, the information processing device 222 transmits PAUSE to the information processing device 221 (401).

Further, the information processing device 222 performs the disconnection process of Wi-Fi Direct with the information processing device 223 (409).

As described above, when the information processing device 223 is disconnected, it is necessary to perform the HDCP reauthentication (406). In this case, because it is necessary to disconnect the L2 connection of Wi-Fi Direct and TCP of RTSP, a fuzzy image or a black image may occur at the time of HDCP reauthentication. In view of this, FIG. 12 illustrates an example in which the dual role device of Wi-Fi CERTIFIED Miracast performs the HDCP reauthentication of changing the role from the repeater to the RX without disconnecting the L2 connection of Wi-Fi Direct and the TCP connection of RTSP.

Further, respective processes (412 and 414) illustrated in FIG. 12 correspond to the respective processes (406 and 409) illustrated in FIG. 11. Thus, descriptions of the corresponding processes will be omitted.

Before the HDCP reauthentication (412), the information processing device 222 issues the PAUSE command to the information processing device 221 (411). The occurrence of a fuzzy image or a black image can be prevented by issuing this PAUSE command.

Then, the information processing device 222 performs the HDCP reauthentication with the information processing device 221 (412). Then, the information processing device 222 issues the PLAY command to the information processing device 221 (413) after the HDCP reauthentication (412).

Accordingly, it is possible to smoothly output images and sounds after the re-authentication without disconnecting the L2 connection of Wi-Fi Direct or the TCP connection of RT SP.

As described above, the control unit of the information processing device 222 (corresponding to the control unit 120 illustrated in FIG. 1) temporarily suspends the information processing device 221 when the connection with the information processing device 223 is disconnected. Then, the control unit of the information processing device 222 performs the HDCP reauthentication process with the information processing device 221, and resumes the image transmission from the information processing device 221 after the HDCP reauthentication process succeeds. Further, the control unit of the information processing device 222 temporarily suspends the information processing device 221 and then performs the disconnection process with the information processing device 223.

### [Example in Which TX is Disconnected]

Next, an example in which the role of the repeater is changed to the TX when the TX is disconnected will be described.

### [Exemplary Configuration of Communication System]

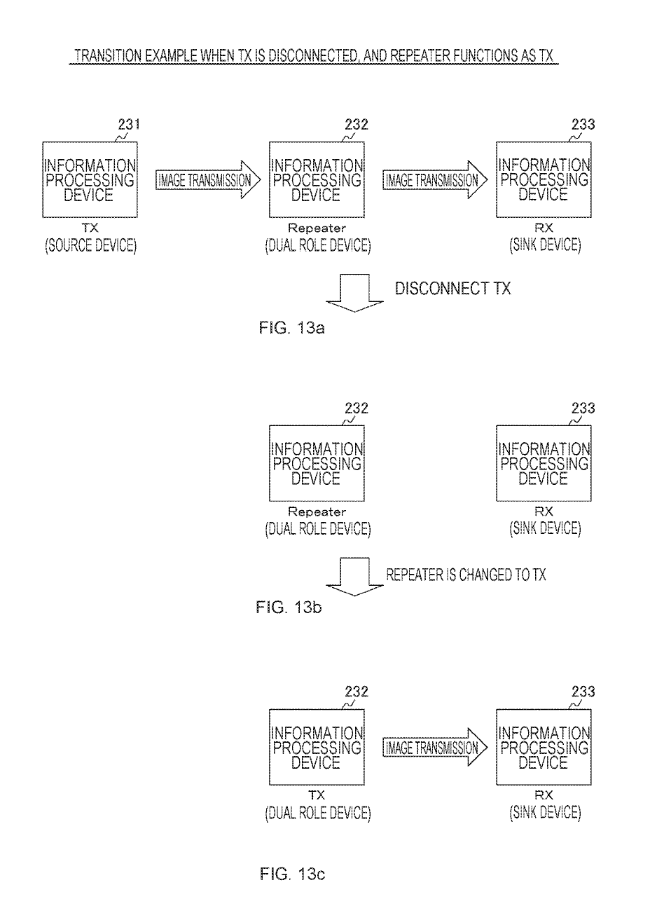

FIG. 13 is a diagram illustrating a system example configuration of a communication system according to the embodiment of the present technology. Each of information processing devices 231 to 233 constituting the communication system illustrated in FIG. 13 corresponds to the information processing device 100 illustrated in FIG. 1. FIG. 13 illustrates a transition example in which the role of the repeater is changed to the TX when the TX is disconnected.

In FIG. 13, a illustrates an example in which a stream is transmitted from the information processing device (TX) 231 to the information processing device (RX) 233 via the information processing device (the repeater) 232 in accordance with Wi-Fi CERTIFIED Miracast.

In FIG. 13, b illustrates an example in which the information processing device (TX) 231 is disconnected (for example, TEARDOWN or radio disconnection) in the state illustrated in a of FIG. 13. As described above, when the information processing device (TX) 231 is disconnected, the role of the information processing device 232 is changed from the repeater to the TX.

In FIG. 13, c illustrates an example in which a stream is transmitted from the information processing device (TX) 232 to the information processing device (RX) 233 in accordance with Wi-Fi CERTIFIED Miracast.

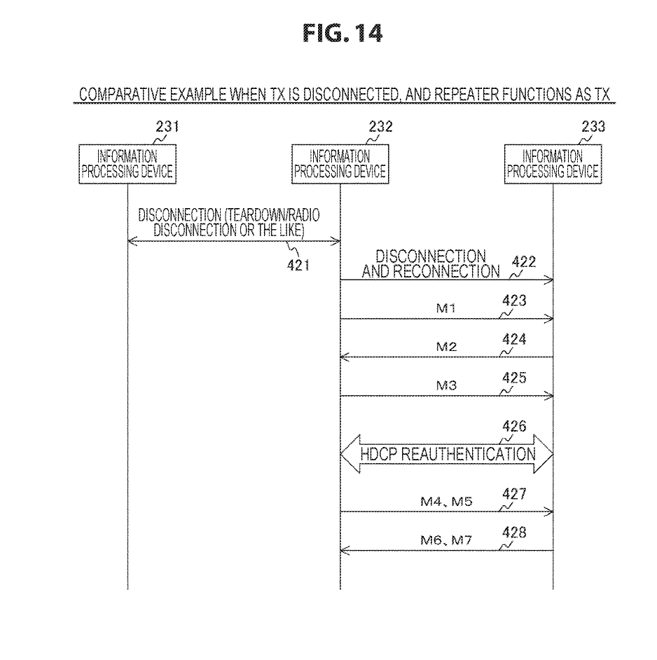

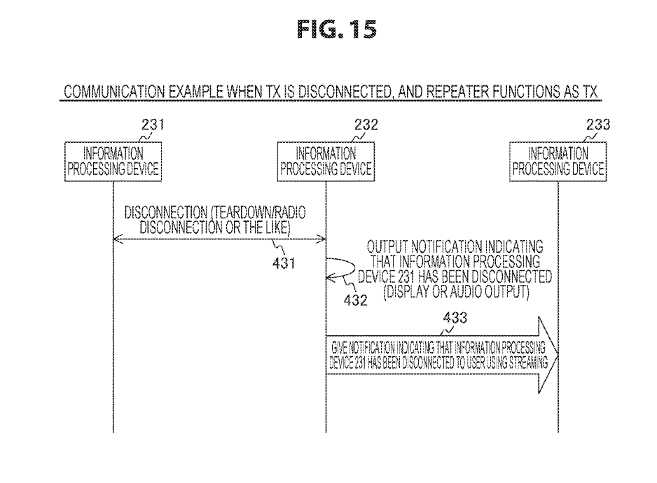

The communication examples will be described in detail with reference to FIGS. 14 and 15.

### [Communication Examples]

FIGS. 14 and 15 are sequence charts illustrating exemplary communication processes among devices constituting the communication system according to the embodiment of the present technology. In other words, FIGS. 14 and 15 illustrate communication examples in which the role of the repeater is changed to the TX when the TX is disconnected.

FIG. 14 illustrates a comparative example of the communication example illustrated in FIG. 15.

Further, respective processes (422 to 428) illustrated in FIG. 14 correspond to the respective processes (358 to 364) illustrated in FIG. 8. Thus, descriptions of the corresponding processes will be omitted.

The information processing device 232 performs a disconnection process of Wi-Fi Direct with the information processing device 231 (421).

As described above, when the information processing device 231 is disconnected, it is necessary to perform the HDCP reauthentication (426). In this case, it is necessary to disconnect the L2 connection of Wi-Fi Direct and TCP of RTSP. Further, since the image transmission is terminated when the TX is disconnected, a black image may be displayed at the time of HDCP reauthentication.

Here, even when the device on the TX side (the device on the most upstream side) is changed (disconnected), a device next on the TX side (next to the upstream device) holds the Revocation information. For this reason, the HDCP reauthentication can be omitted. In this regard, FIG. 12 illustrates an example in which the HDCP reauthentication is omitted and streaming is continued.

A process (431) illustrated in FIG. 15 corresponds to the process (421) illustrated in FIG. 14. For this reason, description of the corresponding process will be omitted.

After the disconnection process of Wi-Fi Direct with the information processing device 231 (431), the information processing device 232 outputs notification information for giving the user a notification indicating that the TX (the information processing device 231) has been disconnected (432). For example, the information processing device 232 causes the display unit to display a notification screen for giving the user a notification indicating that the TX (the information processing device 231) has been disconnected (for example, an input switching screen or a warning screen) (432). Further, for example, the information processing device 232 causes the audio output unit to output a message for giving the user a notification indicating that the TX (the information processing device 231) has been disconnected (432). The notification information may be automatically output when the information processing device 232 detects that the TX (the information processing device 231) is disconnected, and a black image is displayed on the display unit of the RX (the information processing device 233).

Further, after the disconnection process of Wi-Fi Direct with the information processing device 231 (431), the information processing device 233 omits the HDCP reauthentication and continues the streaming (433). In this case, the information processing device 232 can transmit the notification information for giving the user a notification indicating that the TX (the information processing device 231) has been disconnected to the information processing device 233 (433). For example, the information processing device 232 can transmit the notification information to the information processing device 233 using UIBC or the like (433).

Accordingly, it is possible to smoothly output images and sounds after the re-authentication without disconnecting the L2 connection of Wi-Fi Direct or the TCP connection of RTSP.

In this manner, when the connection with the information processing device 231 is disconnected, the control unit of the information processing device 232 (corresponding to the control unit 120 illustrated in FIG. 1) outputs the notification information indicating that the connection with the information processing device 231 is disconnected. For example, the control unit of the information processing device 232 can cause the notification information to be output from at least one of the information processing device 232 and the information processing device 233. Further, the control unit of the information processing device 232 can cause the notification information to be output through at least one of a display of the notification information and an audio output of the notification information.

### [Operation Examples of Information Processing Device]

Next, operation examples of the information processing device will be described.

### [Operation Example When New Information Processing Device is Added]

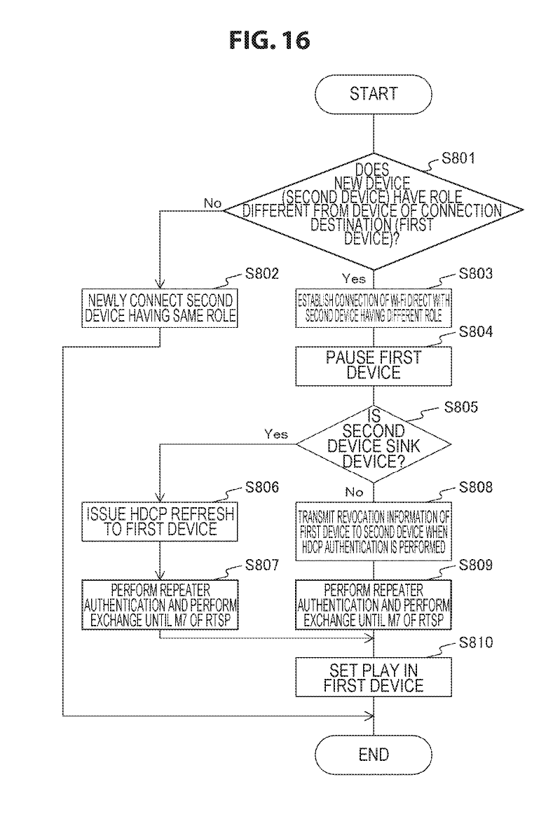

FIG. 16 is a flowchart illustrating an example of the procedure of the connection process by the information processing device 100 according to the embodiment of the present technology. FIG. 16 illustrates an example in which the information processing device 100 is the dual role device of Wi-Fi CERTIFIED Miracast. Further, FIG. 16 illustrates an example in which a new information processing device is added when communication of image data according to Wi-Fi CERTIFIED Miracast is being performed.

First, the control unit 120 of the information processing device 100 determines whether or not a newly connected information processing device (second device) has a different role (Wi-Fi CERTIFIED Miracast) from an already connected information processing device (first device) (step S801). Here, the role of Wi-Fi CERTIFIED Miracast is the source device or the sink device. Further, step S801 is an example of a process of determining in the claims set forth below.

When the new information processing device (second device) has the same role as the already connected information processing device (first device) (step S801), the control unit 120 is newly connected to the information processing device (second device) (step S802).

When the new information processing device (second device) has a different role from the already connected information processing device (first device) (step S801), the control unit 120 establishes a connection of Wi-Fi Direct with an information processing device (second device) (step S803).

Then, the control unit 120 PAUSEs the already connected information processing device (first device) (step S804). For example, when the already connected information processing device (first device) is the source device, the information processing device (first device) is PAUSEd by issuing PAUSE to the information processing device (first device). Further, for example, when the already connected information processing device (first device) is the sink device, the information processing device (first device) is PAUSEd by issuing the Trigger Method PAUSE to the information processing device (first device).

Then, the control unit 120 determines whether or not the new information processing device (second device) is the sink device (step S805). When the new information processing device (second device) is the sink device (step S805), the control unit 120 issues HDCP Refresh to the already connected information processing device (first device) (step S806).

Then, the control unit 120 performs the repeater authentication (HDCP reauthentication) with the new information processing device (second device), and performs an exchange until the M7 message of RTSP (step S807).

Further, when the new information processing device (second device) is the source device (step S805), the control unit 120 transmits the Revocation information of the already connected information processing device (first device) (step S808). In other words, when the HDCP authentication with the new information processing device (second device) is performed, the control unit 120 transmits the Revocation information of the already connected information processing device (first device) (step S808).

Then, the control unit 120 performs the repeater authentication (HDCP reauthentication) with the new information processing device (second device), and performs an exchange until the M7 message of RTSP (step S809).

Then, the control unit 120 sets PLAY in the already connected information processing device (first device) (step S810). For example, when the already connected information processing device (first device) is the source device, PLAY is set in the information processing device (first device) by issuing PLAY to the information processing device (first device). Further, for example, when the already connected information processing device (first device) is the sink device, PLAY is set in the information processing device (first device) by issuing the Trigger Method PLAY to the information processing device (first device). Steps S803 to S810 are an example of a process of performing an authentication process described in the claims set forth below.

### [Operation Example When Information Processing Device is Disconnected]

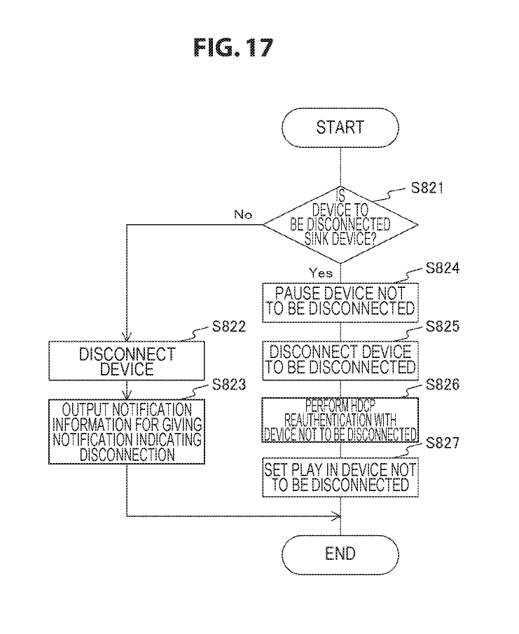

FIG. 17 is a flowchart illustrating an example of a procedure of the disconnection process performed by the information processing device 100 according to the embodiment of the present technology. FIG. 17 illustrates an example in which the information processing device 100 is the dual role device of Wi-Fi CERTIFIED Miracast. Further, FIG. 17 illustrates an example in which the information processing device is disconnected when communication of image data according to Wi-Fi CERTIFIED Miracast is being performed.

First, the control unit 120 of the information processing device 100 determines whether or not the information processing device to be disconnected is the sink device (step S821).

When the information processing device to be disconnected is the source device (step S821), the control unit 120 performs disconnection from the information processing device (the source device) (step S821). Then, the control unit 120 outputs the notification information for giving the user a notification indicating that the information processing device (the source device) has been disconnected from the information output unit 150 (step S823). For example, the control unit 120 causes the display unit to display the notification screen for giving the user a notification indicating that the information processing device (the source device) has been disconnected (step S823). Further, for example, the control unit 120 can give the user a notification by transmitting the notification information for giving the user a notification indicating that the information processing device (the source device) has been disconnected to another connected information processing device (the sink device). For example, the control unit 120 can transmit the notification information for giving the user a notification indicating that the information processing device (the source device) has been disconnected to another information processing device (the sink device) using streaming.

When the information processing device to be disconnected is the sink device (step S821), the control unit 120 PAUSEs the information processing device (the source device) that is not to be disconnected (step S824).

Then, the control unit 120 performs a disconnection from the information processing device (the sink device) to be disconnected (step S825). Then, the control unit 120 performs the HDCP reauthentication with the information processing device (the source device) not to be disconnected (step S826).

Then, the control unit 120 sets PLAY in the information processing device (the source device) that is not to be disconnected (step S827). In other words, the control unit 120 sets PLAY in the information processing device (the source device) by issuing PLAY to the information processing device (the source device) that is not to be disconnected.

Thus, in the embodiment of the present technology, it is possible to prevent the occurrence of a fuzzy image or a black image at the time of topology conversion in which the dual role device of Wi-Fi CERTIFIED Miracast changes it role from the TX to the repeater and increase the speed of the connection time. Similarly, it is possible to prevent the occurrence of a fuzzy image or a black image at the time of topology conversion in which the dual role device of Wi-Fi CERTIFIED Miracast changes its role from the RX to the repeater and increase the speed of the connection time.

Further, it is possible to prevent the occurrence of a fuzzy image or a black image at the time of topology conversion in which the dual role device of Wi-Fi CERTIFIED Miracast changes its role from the repeater to the TX and increase the speed of the connection time. Likewise, it is possible to prevent a fuzzy image at the time of topology conversion in which the dual role device of the Wi-Fi CERTIFIED Miracast changes its role from the repeater to the RX and increase the speed of the connection time.

As described above, according to the embodiments of the present technology, when the real time image transmission according to Wi-Fi CERTIFIED Miracast is performed, it is possible to appropriately perform a connection between information processing devices.

### 2. Application Examples

The technology according to the present disclosure can be applied to various products. For example, the information processing devices 100 may be realized as mobile terminals such as smartphones, tablet personal computers (PCs), notebook PCs, portable game terminals, or digital cameras, fixed-type terminals such as television receivers, printers, digital scanners, or network storages, or car-mounted terminals such as car navigation devices. Further, the information processing devices 100 may be realized as terminals (also referred to as machine type communication (MTC) terminals) which perform machine to machine (M2M) communication, such as smart meters, vending machine, remote monitoring devices and point of sale (POS) terminals. Furthermore, the information processing devices 100 may be wireless communication modules mounted in such terminals (for example, integrated circuit modules configured in one die).

### 2-1. First Application Example

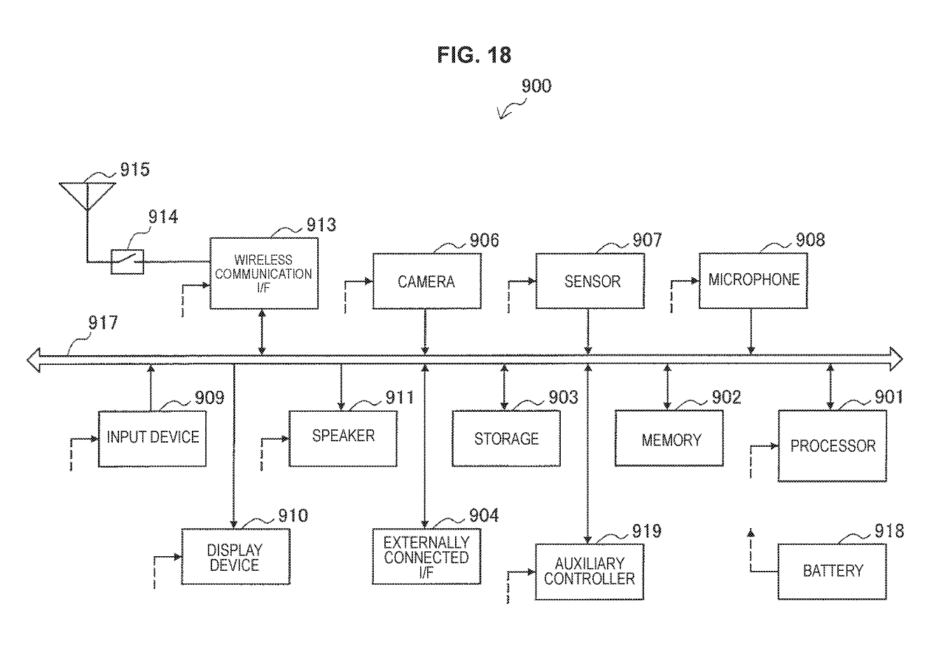

FIG. 18 is a block diagram showing an example of a schematic configuration of a smartphone 900 to which the technology of the present disclosure can be applied. The smartphone 900 includes a processor 901, a memory 902, a storage 903, an externally connected interface 904, a camera 906, a sensor 907, a microphone 908, a input device 909, a display device 910, a speaker 911, a wireless communication interface 913, an antenna switch 914, an antenna 915, a bus 917, a battery 918, and an auxiliary controller 919.

The processor 901 may be, for example, a central processing unit (CPU) or a system on chip (SoC), and controls functions of an application layer and other layers of the smartphone 900. The memory 902 includes a random access memory (RAM) and a read only memory (ROM), and stores programs executed by the processor 901 and data. The storage 903 can include a storage medium such as a semiconductor memory or a hard disk. The externally connected interface 904 is an interface for connecting an externally attached device such as a memory card or a universal serial bus (USB) device to the smartphone 900.

The camera 906 has an image sensor, for example, a charge coupled device (CCD) or a complementary metal oxide semiconductor (CMOS) to generate captured images. The sensor 907 can include a sensor group including, for example, a positioning sensor, a gyro sensor, a geomagnetic sensor, an acceleration sensor, and the like. The microphone 908 converts sounds input to the smartphone 900 into audio signals. The input device 909 includes, for example, a touch sensor that detects touches on a screen of the display device 910, a key pad, a keyboard, buttons, switches, and the like to receive manipulations or information inputs from a user. The display device 910 has a screen such as a liquid crystal display (LCD), or an organic light emitting diode (OLED) display to display output images of the smartphone 900. The speaker 911 converts audio signals output from the smartphone 900 into sounds.

The wireless communication interface 913 supports one or more wireless LAN standards of IEEE 802.11a, 11b, 11g, 11n, 11ac, and 11ad to execute the wireless LAN communication. The wireless communication interface 913 can communicate with another apparatus via a wireless LAN access point in an infrastructure mode. In addition, the wireless communication interface 913 can directly communicate with another apparatus in a direct communication mode such as an ad hoc mode, Wi-Fi Direct, or the like. Wi-Fi Direct is different from the ad hoc mode, and thus one of two terminals operates as an access point. However, communication is performed directly between the terminals. The wireless communication interface 913 can typically include a baseband processor, a radio frequency (RF) circuit, a power amplifier, and the like. The wireless communication interface 913 may be a single-chip module on which a memory that stores a communication control program, a processor that executes the program, and a relevant circuit are integrated. The wireless communication interface 913 may support another kind of wireless communication scheme such as a cellular communication scheme, a short-range wireless communication scheme, or a proximity wireless communication scheme in addition to the wireless LAN scheme. The antenna switch 914 switches a connection destination of the antenna 915 for a plurality of circuits (for example, circuits for different wireless communication schemes) included in the wireless communication interface 913. The antenna 915 has a single or a plurality of antenna elements (for example, a plurality of antenna elements constituting a MIMO antenna), and is used for transmission and reception of wireless signals from the wireless communication interface 913.

Note that the smartphone 900 may include a plurality of antennas (for example, antennas for a wireless LAN or antennas for a proximity wireless communication scheme, or the like), without being limited to the example of FIG. 18. In this case, the antenna switch 914 may be omitted from the configuration of the smartphone 900.

The bus 917 connects the processor 901, the memory 902, the storage 903, the externally connected interface 904, the camera 906, the sensor 907, the microphone 908, the input device 909, the display device 910, the speaker 911, the wireless communication interface 913, and the auxiliary controller 919 to one another. The battery 918 supplies electric power to each of the blocks of the smartphone 900 shown in FIG. 18 via power supply lines partially indicated by dashed lines in the drawing. The auxiliary controller 919 causes, for example, required minimum functions of the smartphone 900 to be operated in a sleep mode.

In the smartphone 900 shown in FIG. 18, the control unit 120 described with reference to FIG. 1 may be mounted on the wireless communication interface 913. At least some of the functions may be mounted on the processor 901 or the auxiliary controller 919.

The smartphone 900 may operate as a wireless access point (software AP) when the processor 901 performs an access point function at an application level. The wireless communication interface 913 may have the wireless access point function.

### 2-2. Second Application Example

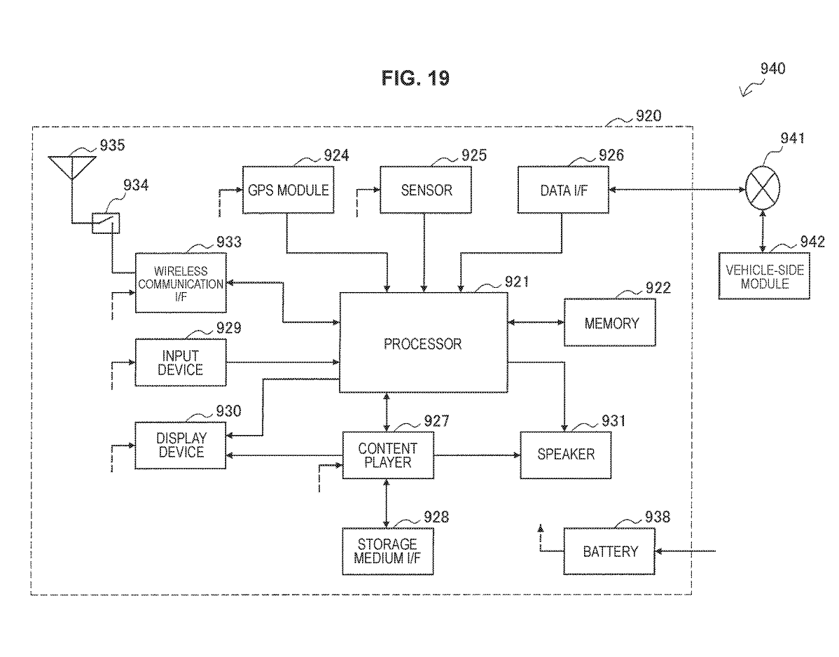

FIG. 19 is a block diagram showing an example of a schematic configuration of a car navigation apparatus 920 to which the technology of the present disclosure can be applied. The car navigation apparatus 920 includes a processor 921, a memory 922, a global positioning system (GPS) module 924, a sensor 925, a data interface 926, a content player 927, a storage medium interface 928, an input device 929, a display device 930, a speaker 931, a wireless communication interface 933, an antenna switch 934, an antenna 935, and a battery 938.

The processor 921 may be, for example, a CPU or an SoC controlling a navigation function and other functions of the car navigation apparatus 920. The memory 922 includes a RAM and a ROM storing programs executed by the processor 921 and data.

The GPS module 924 measures a position of the car navigation apparatus 920 (for example, latitude, longitude, and altitude) using GPS signals received from a GPS satellite. The sensor 925 can include a sensor group including, for example, a gyro sensor, a geomagnetic sensor, a barometric sensor, and the like. The data interface 926 is connected to an in-vehicle network 941 via, for example, a terminal that is not illustrated to acquire data generated on the vehicle side such as car speed data.

The content player 927 reproduces content stored in a storage medium (for example, a CD or a DVD) inserted into the storage medium interface 928. The input device 929 includes, for example, a touch sensor that detects touches on a screen of the display device 930, buttons, switches, and the like to receive manipulations or information inputs from a user. The display device 930 has a screen such as an LCD or an OLED display to display images of the navigation function or reproduced content. The speaker 931 outputs sounds of the navigation function or reproduced content.

The wireless communication interface 933 supports one or more wireless LAN standards of IEEE 802.11a, 11b , 11g, 11n, 11ac, and 11ad to execute wireless LAN communication. The wireless communication interface 933 can communicate with another apparatus via a wireless LAN access point in the infrastructure mode. In addition, the wireless communication interface 933 can directly communicate with another apparatus in a direct communication mode, such as an ad hoc mode, Wi-Fi Direct, or the like. The wireless communication interface 933 can typically have a baseband processor, an RF circuit, a power amplifier, and the like. The wireless communication interface 933 may be a single-chip module on which a memory that stores a communication control program, a processor that executes the program, and a relevant circuit are integrated. The wireless communication interface 933 may support another kind of wireless communication scheme such as a short-range wireless communication scheme, a proximity wireless communication scheme, or the cellular communication scheme in addition to the wireless LAN scheme. The antenna switch 934 switches a connection destination of the antenna 935 for a plurality of circuits included in the wireless communication interface 933. The antenna 935 has a single or a plurality of antenna elements and is used for transmission and reception of wireless signals from the wireless communication interface 933.

Note that the car navigation apparatus 920 may include a plurality of antennas, without being limited to the example of FIG. 19. In this case, the antenna switch 934 may be omitted from the configuration of the car navigation apparatus 920.

The battery 938 supplies electric power to each of the blocks of the car navigation apparatus 920 shown in FIG. 19 via power supply lines partially indicated by dashed lines in the drawing. In addition, the battery 938 accumulates electric power supplied from the vehicle.

In the car navigation apparatus 920 illustrated in FIG. 19, the control unit 120 described with reference to FIG. 1 may be implemented in the wireless communication interface 933. Further, at least some functions may be implemented in the processor 921.

The technology of the present disclosure may be realized as an in-vehicle system (or a vehicle) 940 including one or more blocks of the above-described car navigation apparatus 920, the in-vehicle network 941, and a vehicle-side module 942. The vehicle-side module 942 generates vehicle-side data such as a vehicle speed, the number of engine rotations, or failure information and outputs the generated data to the in-vehicle network 941.

The above-described embodiments are examples for embodying the present technology and have correspondence relations with factors in embodiments and specific inventive factors in the claims. Similarly, specific inventive factors in the claims and factors in embodiments of the present technology to which the same names as the specific inventive factors are given have correspondence relations. However, the present technology is not limited to the embodiments, but may be realized in various modification forms of the embodiments within the scope without departing from the gist of the present technology.

The processing orders described in the above-described embodiments may be ascertained as methods including the series of orders or may be ascertained as a program causing a computer to execute the series of orders or a recording medium storing the program. As the recording medium, for example, a compact disc (CD), a minidisc (MD), a digital versatile disc (DVD), a memory card, or a Blu-ray (registered trademark) disc can be used.

The advantageous effects described in the present specification are merely examples and are not limitative, and other advantageous effects may be achieved.

Additionally, the present technology may also be configured as below.

(1)

An information processing device, including:

a communication unit configured to perform image transmission to a first information processing device by using wireless communication; and

a control unit configured to temporarily suspend the first information processing device and perform an authentication process with a second information processing device having a different role from the first information processing device if the second information processing device is newly connected when the image transmission is performed.

(2)

The information processing device according to (1),

wherein the communication unit performs real time image transmission to the first information processing device in accordance with a Wireless Fidelity (Wi-Fi) CERTIFIED Miracast specification, and

after the first information processing device is temporarily suspended, the control unit performs an HDCP reauthentication process with each of the first information processing device and the second information processing device.

(3)

The information processing device according to (1),

wherein if a role of the first information processing device is a transmitter, and a role of the information processing device is a receiver in a case where the image transmission is performed, when the role of the information processing device is changed to a relay device due to a connection of the second information processing device, the control unit performs the authentication process with the second information processing device after temporarily suspending the image transmission from the first information processing device, and resumes the image transmission from the first information processing device after the authentication process.

(4)

The information processing device according to (3),

wherein the control unit performs a reauthentication process with the first information processing device after temporarily suspending the image transmission from the first information processing device, and performs the authentication process with the second information processing device after the reauthentication process succeeds.

(5)

The information processing device according to (1),

wherein if a role of the first information processing device is a receiver, and a role of the information processing device is a transmitter in a case where the image transmission is performed, when the role of the information processing device is changed to a relay device due to a connection of the second information processing device, the control unit performs the authentication process with the second information processing device after temporarily suspending the image transmission to the first information processing device, and resumes the image transmission to the first information processing device after the authentication process.

(6)

The information processing device according to (5),

wherein the control unit transmits Revocation information held when a wireless connection with the first information processing device starts to the second information processing device before performing the authentication process with the second information processing device.

(7)

The information processing device according to any of (1) to (6),

wherein the information processing device is a dual role device satisfying a wireless Fidelity (Wi-Fi) CERTIFIED Miracast specification.

(8)

An information processing device, including:

a communication unit configured to relay image transmission from a first information processing device to a second information processing device by using wireless communication; and

a control unit configured to perform a reauthentication process with the first information processing device after temporarily suspending the first information processing device and resume the image transmission from the first information processing device after the reauthentication process when disconnecting a connection with the second information processing device.

(9)

The information processing device according to (8),

wherein the control unit performs a disconnection process from the second information processing device after temporarily suspending the first information processing device.

(10)

An information processing device, including:

a communication unit configured to relay image transmission from a first information processing device to a second information processing device by using wireless communication; and

a control unit configured to cause notification information indicating that a connection with the first information processing device is to be disconnected to be output from at least one of the information processing device and the second information processing device when disconnecting the connection with the first information processing device.

(11)

The information processing device according to (10),

wherein the control unit causes the output to be performed through a display of the notification information or an audio output of the notification information.

(12)

An information processing method, including:

a process of determining whether or not a second information processing device to be newly connected has a role different from a first information processing device when performing image transmission to the first information processing device by using wireless communication; and

a process of performing an authentication process with the second information processing device after temporarily suspending the first information processing device when the second information processing device has the role different from the first information processing device.

### REFERENCE SIGNS LIST

100, 201 to 203, 211 to 213, 221 to 223, 231 to 233 information processing device

110 communication unit

120 control unit

130 storage unit

140 operation receiving unit

150 information output unit

160 communication unit

161 RTSP server

162 RTP server

163 HDCP TX

164 NIC

170 communication unit

171 RT SP server

172 RTP server

173 HDCP RX/TX repeater

174 RTSP client

175 RTP client

176 NIC

180 communication unit

181 RTSP client

182 RTP client

183 HDCP RX

184 NIC

900 smartphone

901 processor

902 memory

903 storage

904 externally connected interface

906 camera

907 sensor

908 microphone

909 input device

910 display device

911 speaker

913 wireless communication interface

914 antenna switch

915 antenna

917 bus

918 battery

919 auxiliary controller

920 car navigation apparatus

921 processor

922 memory

924 GPS module

925 sensor

926 data interface

927 content player

928 storage medium interface

929 input device

930 display device

931 speaker

933 wireless communication interface

934 antenna switch

935 antenna

938 battery

941 in-vehicle network

942 vehicle-side module

1. An information processing device, comprising:
a communication unit configured to perform image transmission to a first information processing device by using wireless communication; and
a control unit configured to temporarily suspend the first information processing device and perform an authentication process with a second information processing device having a different role from the first information processing device if the second information processing device is newly connected when the image transmission is performed.

2. The information processing device according to claim 1,
wherein the communication unit performs real time image transmission to the first information processing device in accordance with a Wireless Fidelity (Wi-Fi) CERTIFIED Miracast specification, and
after the first information processing device is temporarily suspended, the control unit performs an HDCP reauthentication process with each of the first information processing device and the second information processing device.

3. The information processing device according to claim 1,
wherein if a role of the first information processing device is a transmitter, and a role of the information processing device is a receiver in a case where the image transmission is performed, when the role of the information processing device is changed to a relay device due to a connection of the second information processing device, the control unit performs the authentication process with the second information processing device after temporarily suspending the image transmission from the first information processing device, and resumes the image transmission from the first information processing device after the authentication process.

4. The information processing device according to claim 3,
wherein the control unit performs a reauthentication process with the first information processing device after temporarily suspending the image transmission from the first information processing device, and performs the authentication process with the second information processing device after the reauthentication process succeeds.

5. The information processing device according to claim 1,
wherein if a role of the first information processing device is a receiver, and a role of the information processing device is a transmitter in a case where the image transmission is performed, when the role of the information processing device is changed to a relay device due to a connection of the second information processing device, the control unit performs the authentication process with the second information processing device after temporarily suspending the image transmission to the first information processing device, and resumes the image transmission to the first information processing device after the authentication process.

6. The information processing device according to claim 5,
wherein the control unit transmits Revocation information held when a wireless connection with the first information processing device starts to the second information processing device before performing the authentication process with the second information processing device.

7. The information processing device according to claim 1,
wherein the information processing device is a dual role device satisfying a wireless Fidelity (Wi-Fi) CERTIFIED Miracast specification.

8. An information processing device, comprising:
a communication unit configured to relay image transmission from a first information processing device to a second information processing device by using wireless communication; and
a control unit configured to perform a reauthentication process with the first information processing device after temporarily suspending the first information processing device and resume the image transmission from the first information processing device after the reauthentication process when disconnecting a connection with the second information processing device.

9. The information processing device according to claim 8,
wherein the control unit performs a disconnection process from the second information processing device after temporarily suspending the first information processing device.

10. An information processing device, comprising:
a communication unit configured to relay image transmission from a first information processing device to a second information processing device by using wireless communication; and
a control unit configured to cause notification information indicating that a connection with the first information processing device is to be disconnected to be output from at least one of the information processing device and the second information processing device when disconnecting the connection with the first information processing device.

11. The information processing device according to claim 10,
wherein the control unit causes the output to be performed through a display of the notification information or an audio output of the notification information.

12. An information processing method, comprising:
a process of determining whether or not a second information processing device to be newly connected has a role different from a first information processing device when performing image transmission to the first information processing device by using wireless communication; and
a process of performing an authentication process with the second information processing device after temporarily suspending the first information processing device when the second information processing device has the role different from the first information processing device.
